(19) United States
(12) Patent Application Publication
(10) Pub. No.: US 2026/0290677 A1
(43) Pub. Date: Sep. 24, 2026

(54) MULTI-LAYER INDUCTOR AND TRANSFORMER

(71) Applicant: 3M INNOVATIVE PROPERTIES COMPANY, St. Paul, MN (US)

(72) Inventors: Jinwook Kim, Hwaseong-si (KR); Seong-Woo Woo, Gwangju-si (KR); Xiaoming Kou, Woodbury, MN (US); Andrea Stricker, Grevenbroich (DE); Jung Ju Suh, Seocho-gu (KR); Jennifer J. Sokol, Mahtomedi, MN (US)

(21) Appl. No.: 19/472,771

(22) PCT Filed: Apr. 1, 2024
(86) PCT No.: PCT/IB2024/053157

§ 371 Date: Oct. 6, 2025

Related U.S. Application Data
(60) Provisional application No. 63/459,749, filed on Apr. 17, 2023.

(51) Int. Cl. H01F 27/28; H01F 27/245

(52) U.S. Cl. CPC H01F 27/2847; H01F 27/245

(57) ABSTRACT

A planar transformer lying in a base plane defining orthogonal in-plane azimuth and radial directions includes a planar first coil portion and a planar core portion. The first coil portion is disposed in the base plane and includes concentric first coil loops having an innermost first coil loop and an outermost first coil loop. Each of the first coil loops includes elongated first layers. The elongated first layers include at least one electrically conductive first layer and at least one adhesive first layer. The core portion is disposed in the base plane and, at least partially, in an opening defined by the innermost first coil loop and has a plurality of second layers stacked along one of the radial direction and a height direction orthogonal to the base plane. The plurality of second layers includes at least one magnetically permeable second layer and at least one adhesive second layer.

### SUMMARY

In some aspects of the present description, a generally planar transformer is provided, the generally planar transformer generally lying in a base plane defining mutually orthogonal in-plane azimuth and radial directions and including a generally planar first coil portion and a generally planar core portion. The generally planar first coil portion is generally disposed in the base plane and includes a plurality of substantially concentric first coil loops having an innermost first coil loop and an outermost first coil loop. Each of the first coil loops includes a plurality of elongated first layers elongated and extending along the azimuth direction and stacked along the radial direction. The plurality of elongated first layers includes at least one electrically conductive first layer and at least one adhesive first layer. The generally planar core portion is generally disposed in the base plane and, at least partially, in an opening defined by the innermost first coil loop of the first coil portion and comprising a plurality of second layers stacked along one of the radial direction and a height direction orthogonal to the base plane. The plurality of second layers includes at least one magnetically permeable second layer and at least one adhesive second layer.

In some aspects of the present description, a transformer is provided, the transformer including electrically conductive primary and secondary coils stacked along a height direction and electrically isolated from each other. The first and second coil portions define respective first and second central openings aligned with each other along the height direction. A core is disposed within the first and second central openings and includes a plurality of substantially planar and co-extensive magnetically permeable layers numbering at least 10 in total, and bonded to each other and stacked along the height direction.

In some aspects of the present description, a magnetically permeable core for use in a transformer is provided, the magnetically permeable core having an average height H1 in a height direction and a largest lateral dimension D1, such that D1/H1 greater than or equal to about 2. The magnetically permeable core includes a plurality of substantially planar and co-extensive magnetically permeable alloy layers numbering at least 50 in total stacked along the lateral direction and bonded to each other via a plurality of adhesive layers. The magnetically permeable alloy layers are intentionally cracked across substantially an entirety of the layers to form a plurality of magnetically permeable alloy islands isolated from each other by a plurality of interconnected cracks.

In some aspects of the present description, a method of making a magnetically permeable core for use in a transformer is provided, the method including the steps of providing a multilayer film having a plurality of alternating magnetically permeable alloy layers and adhesive layers, winding the multilayer film around a longitudinal axis to form a wound multilayer film having a plurality of substantially concentric turns of the multilayer film substantially centered on the longitudinal axis, and cutting the wound multilayer film into at least one slice along parallel radial planes to form the core.

In some aspects of the present description, a method of making a magnetically permeable core for use in a transformer is provided, the method including the steps of providing a multilayer stack having a plurality of alternating magnetically permeable alloy layers and adhesive layers stacked along a first direction, and cutting the multilayer stack into at least one slice along parallel planes orthogonal to the first direction to form the core.

### BRIEF DESCRIPTION OF THE DRAWINGS

FIGS. 1A-1C provide views of a generally planar transformer, in accordance with an embodiment of the present description;

FIGS. 2A-2D provide additional views of a generally planar transformer, in accordance with an embodiment of the present description;

FIGS. 3A-3B are images of a magnetically permeable second layer which has been intentionally cracked to form cracks defining magnetically permeable islands, in accordance with an embodiment of the present description;

FIGS. 4A-4B illustrate how the surfaces of a magnetically permeable core may include a regular pattern of parallel features, in accordance with an embodiment of the present description;

FIG. 5 illustrates one method of making a magnetically permeable core for use in a transformer, in accordance with an embodiment of the present description; and

FIG. 6 illustrates another method of making a magnetically permeable core for use in a transformer, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

An inductor, or transformer, is an essential component in power electronics, especially for power conversion circuits such as AC-DC converters and DC-DC converters. It is also a component in EMI filters (e.g., common mode and differential mode noise filters). It typically consists of a loop made of electrical conductors (e.g., wires or conductive patterns) with magnetic materials (e.g., NiZn ferrite, MnZn ferrite, nanocrystalline, etc.) as a core material. Multistrand (Litz) wires or solid copper wires are usually used to make the conducting loops of the inductors and transformers.

Transformers like these experience power losses due to the skin and proximity effects and magnetic losses of the core materials. At high frequencies, the losses seen by the inductors can increase significantly. It is possible to embed a wired coil in a printed circuit board, but the thinness of the transformer is limited by the wire conductors of the coil. Many applications are looking for more stable, thinner transformers, with reduced weight.

It should be noted that, as used throughout this specification, the term “transformer” shall be assumed to include both transformers and inductors. That is, the various embodiments of transformers described herein may also be used as inductors as appropriate. For example, the primary coil described elsewhere herein may be used as a single inductor in certain applications, and, in embodiments described as having both a first (primary) coil and a secondary coil, the coils may be used in certain applications as coupled inductors.

According to some aspects of the present description, a new design is provided, wherein the magnetic core is built as an epoxy-based ferromagnetic core, with a construction of alternating magnetically permeable layers and adhesive layers. For the purposes of this specification, the term “adhesive” shall refer to any appropriate adhesive or binder component, including organic adhesive and inorganic adhesives. Such an approach creates a magnetic core which exhibits an increased thermal reliability and mechanical strength, can be reduced in thickness, is flexible and easy to handle without stress-induced fractures during handling, and is less expensive to produce than existing core solutions.

According to some aspects of the present description, a generally planar transformer is generally lying in a base plane (e.g., an xy-plane in a Cartesian coordinate system, where the z-direction is a thickness direction) defining mutually orthogonal in-plane azimuth and radial directions. In some embodiments, the generally planar transformer may include a generally planar first coil portion (e.g., a primary coil) and a generally planar core portion.

In some embodiments, the generally planar first coil portion may be generally disposed in the base plane and including a plurality of substantially concentric first coil loops. The first coil loops, in some embodiments, may include an innermost first coil loop and an outermost first coil loop. In some embodiments, each of the first coil loops may include a plurality of elongated first layers elongated and extending along the azimuth direction and stacked along the radial direction. In some embodiments, the plurality of elongated first layers may include at least one electrically conductive first layer and at least one adhesive first layer.

In some embodiments, the generally planar core portion may be generally disposed in the base plane and, at least partially, in an opening defined by the innermost first coil loop of the first coil portion. The generally planar core portion may include a plurality of second layers stacked along one of the radial direction and a height direction (e.g., the z-axis) orthogonal to the base plane. In some embodiments, the plurality of second layers may include at least one magnetically permeable second layer and at least one adhesive second layer.

In some embodiments, the generally planar first coil portion may include a first multilayer film extending between opposing first and second longitudinal ends of the first multilayer film and wound to form the plurality of substantially concentric first coil loops. In some embodiments, one of the innermost and outermost first coil loops may include the first longitudinal end of the first multilayer film and the other one of the innermost and outermost first coil loops includes the second longitudinal end of the first multilayer film. For example, the first multiplayer film may be wound about itself to create concentric loops, with one end of the film inside the wound film (on the innermost layer) and the other end of the film on the outside of the wound film (on the outermost layer). In some embodiments, the first and second longitudinal ends of the first multilayer film may be electrically connected to respective first and second electrically conductive terminals.

In some embodiments, any magnetic permeability of any first layer in the plurality of elongated first layers of each of the first coil loops may be substantially smaller than a magnetic permeability of the at least one magnetically conductive second layer in the plurality of second layers. In some embodiments, any electrical conductivity of any second layer in the plurality of second layers is substantially smaller than an electrical conductivity of the at least one electrically conductive first layer in the plurality of elongated first layers of each of the first coil loop.

In some embodiments, the plurality of elongated first layers of each of the first coil loops may further include at least one magnetically permeable first layer. In some embodiments, the plurality of elongated first layers of each of the first coil loops may further include at least one non-adhesive electrically insulative first layer.

In some embodiments, the plurality of second layers may further include at least one electrically conductive second layer. In some embodiments, the plurality of second layers may further include at least one non-adhesive electrically insulative second layer.

In some embodiments, the generally planar coil and core portions may be at least partially embedded in an electrically insulative and magnetically non-permeable substrate. In some such embodiments, the substrate may include a Flame Retardant 4 (FR4) substrate. In some such embodiments, the generally planar transformer may further include at least one ground layer embedded in the substrate.

It should be noted that, as used herein, the term “magnetically permeable” shall refer to materials with a relative permeability greater than or equal to about 2.0 (i.e., “magnetic materials”), and the term “non-permeable” shall refer to materials with a relative permeability of approximately 1.0 (i.e., “non-magnetic materials”).

In some embodiments, the second layers in the generally planar core portion may be stacked along the height direction. In other embodiments, the second layers in the generally planar core portion may be stacked along the radial direction.

In some embodiments of the generally planar transformer, it may further include a generally planar second coil portion (e.g., a secondary coil) generally disposed in the base plane and having a plurality of substantially concentric second coil loops. In some embodiments, the substantially concentric second coil loops may include an innermost second coil loop and an outermost second coil loop. In some embodiments, each of the second coil loops may include a plurality of elongated third layers elongated and extending along the azimuth direction and stacked along the radial direction. In some such embodiments, the plurality of elongated third layers may include at least one electrically conductive third layer and at least one adhesive third layer. In some such embodiments, the generally planar core portion may be at least partially disposed in an opening defined by the innermost second coil loop of the second coil portion. In some such embodiments, the generally planar second coil portion may include a second multilayer film extending between opposing first and second longitudinal ends of the second multilayer film and wound to form the plurality of substantially concentric second loops. In some embodiments, one of the innermost and outermost second coil loops includes the first longitudinal end of the second multilayer film and the other one of the innermost and outermost second coil loops includes the second longitudinal end of the second multilayer film. In some such embodiments, the first and second longitudinal ends of the second multilayer film may be electrically connected to respective third and fourth electrically conductive terminals.

In some embodiments, the at least one electrically conductive first layer of the generally planar transformer may include a metal. In some such embodiments, the metal may include one or more of aluminum, titanium, copper, silver, and gold.

In some embodiments, the at least one magnetically permeable second layer of the generally planar transformer may include one or more of magnetically conductive ferrite, soft magnet, metal, crystalline alloy, nanocrystalline alloy, amorphous alloy, and composite. In some such embodiments, the magnetically conductive ferrite may include one or more of a manganese-zinc ferrite, and a nickel-zinc ferrite. In some such embodiments, the magnetically conductive metal may include an alloy comprising iron. In some such embodiments, the magnetically conductive alloy may further include one or more of silicon, aluminum, boron, niobium, copper, cobalt, nickel, and molybdenum. In other such embodiments, the magnetically conductive alloy further comprises one or more of silicon, boron, niobium, and copper.

In some embodiments, the magnetically conductive crystalline alloy may include two or more of iron, cobalt and nickel. In some embodiments, the magnetically conductive nanocrystalline alloy may include iron, silicon, boron, niobium, and copper. In some embodiments, the magnetically conductive amorphous alloy may include cobalt or iron, and one or more of silicon and boron.

In some embodiments, the magnetically conductive composite may include particles dispersed in a binder. In some such embodiments, the particles may include metallic particles. In some such embodiments, the metallic particles may include an iron-aluminum-silicon alloy.

In some embodiments, the at least one magnetically permeable second layer may be intentionally cracked across substantially an entirety of the second layer to form a plurality of interconnected cracks defining a plurality of magnetically permeable islands. In some embodiments, the at least one magnetically permeable second layer is cracked to form a plurality of interconnected cracks defining a plurality of magnetically permeable islands.

In some embodiments, the generally planar core portion may include at least 10, or at least 20, or at least 50, or at least 75, or at least 100, or at least 150, or at least 200, or at least 250, or at least 300, or at least 350, or at least 400 spaced-apart magnetically permeable second layers. In some embodiments, each of the at least one magnetically permeable second layer may have an average thickness of greater than about 0.3 microns, or greater than about 0.4 microns, or greater than about 0.5 microns, or greater than about 1 micron, or greater than about 2 microns, or greater than about 5 microns, or greater than about 7 microns, or greater than about 10 microns, or greater than about 15 microns. In some embodiments, each of the at least one magnetically permeable second layers may have an average thickness of less than about 50 microns, or less than about 45 microns, or less than about 40 microns, or less than about 35 microns, or less than about 30 microns, or less than about 25 microns. In some embodiments, each of the at least one first and second adhesive layers may have an average thickness of less than about 20 microns, or less than about 15 microns, or less than about 10 microns.

In some embodiments, from a top, planar view (e.g., looking down along the z-axis, or thickness direction of the transformer) the generally planar core portion may have an oval, circular, square, rectangular, or any other appropriate shape. In some embodiments, the generally planar core portion may define a central opening extending across an entire thickness of the core portion. In some embodiments, the generally planar core portion may include a plurality of repeat units stacked along one of the radial and height directions. In some such embodiments, each of the repeat units may include a magnetically permeable second layer and an adhesive second layer. In some such embodiments, the generally planar core portion may have at least 20, or at least 50, or at least 75, or at least 100, or at least 200, or at least 300, or at least 400 repeat units. In some embodiments, the generally planar core portion may be electrically isolated from the generally planar first coil portion. In some embodiments, the generally planar core portion may be electrically grounded.

In some embodiments, a largest lateral dimension D1 of the generally planar core portion may be less than about 50 mm, or less than about 45 mm, or less than about 40 mm, or less than about 35 mm, or less than about 30 mm, or less than about 25 mm, or less than about 20 mm, or less than about 15 mm, or less than about 10 mm. In some embodiments, a largest lateral dimension D2 of the generally planar first coil portion is less than about 50 mm, or less than about 45 mm, or less than about 40 mm, or less than about 35 mm, or less than about 30 mm, or less than about 25 mm, or less than about 20 mm, or less than about 15 mm, or less than about 10 mm.

In some embodiments, the generally planar transformer may further include a generally planar third coil portion having an elongated third multilayer film elongated along a length L1 thereof between opposing first and second longitudinal ends of the elongated third multilayer film and wound in the azimuth direction to form a plurality of substantially concentric third coil loops arranged along radial direction and comprising an innermost third coil loop and an outermost third coil loop. In some embodiments, the innermost third coil loop may include the first longitudinal end of the third multilayer film and the outermost third coil loop may include the second longitudinal end of the third multilayer film. In some embodiments, the elongated third multilayer film may include a plurality of elongated third layers having at least one magnetically permeable third layer and at least one adhesive third layer. In some embodiments, the generally planar first coil portion and the generally planar core portion are disposed, at least partially, in an opening defined by the innermost third coil loop of the generally planar third coil portion. In some such embodiments, a largest lateral dimension D3 of the generally planar third coil portion may be less than about 200 mm, or less than about 175, or less than about 150, or less than about 125, or less than about 100, or less than about 75, or less than about 50, or less than about 45, or less than about 40, or less than about 35, or less than about 30 mm. In some embodiments, an average height H1 of the generally planar core portion along the height direction (e.g., a z-axis) is less than about 10 mm, or less than about 9 mm, or less than about 8 mm, or less than about 7 mm, or less than about 6 mm, or less than about 5 mm, or less than about 4 mm, or less than about 3 mm, or less than about 2 mm, or less than about 1 mm.

According to some aspects of the present description, a transformer includes electrically conductive primary and secondary coils stacked along a height direction (e.g., a z-axis of the transformer) and electrically isolated from each other, and a core. In some embodiments, the first and second coil portions may define respective first and second central openings aligned with each other along the height direction. In some embodiments, the core may be disposed within the first and second central openings and may include a plurality of substantially planar (e.g., in an xy-plane of the transformer) and co-extensive magnetically permeable layers numbering at least 10, or at least 25, or at least 50, or at least 75, or at least 100, or at least 150, or at least 200, or at least 250, or at least 300, or at least 350, or at least 400 in total, and bonded to each other and stacked along the height direction. In some embodiments, the core may have an average height H1 in the height direction and a largest lateral dimension D1, such that the ratio D1/H1 is greater than or equal to about 2, or about 3, or about 4, or about 5, or about 10, or about 15, or about 20. In some embodiments, the core may be disc shaped.

In some embodiments, the magnetically permeable layers may be intentionally cracked across substantially an entirety of the layers to form a plurality of interconnected cracks defining a plurality of magnetically permeable islands.

According to some aspects of the present description, a magnetically permeable core for use in a transformer may have an average height H1 in a height direction and a largest lateral dimension D1, such that the ratio D1/H1 is greater than or equal to about 2, or about 3, or about 4, or about 5, or about 10, or about 15, or about 20. In some embodiments, the magnetically permeable core may include a plurality of substantially planar (e.g., the xy-plane) and co-extensive magnetically permeable alloy layers numbering at least 50, or at least 75, or at least 100, or at least 150, or at least 200, or at least 250, or at least 300, or at least 350, or at least 400 in total stacked along the lateral direction and bonded to each other via a plurality of adhesive layers. In some embodiments, the magnetically permeable alloy layers may be intentionally cracked across substantially an entirety of the layers to form a plurality of magnetically permeable alloy islands isolated from each other by a plurality of interconnected cracks.

In some embodiments, the magnetically permeable alloy of the magnetically permeable alloy layers may include magnetically permeable nanocrystalline alloy. In some such embodiments, the nanocrystalline alloy may include one or more of iron, silicon, boron, niobium, and copper. In some embodiments, the magnetically permeable core may have a shape of a disc, a toroid, a doughnut, an ellipsoid, or a coil. In embodiments where the magnetically permeable core has a disk shape, the disc-shaped core may have at least one central through-opening. In some embodiments, when viewed along the height direction, the core has an oval, circular, square, or rectangular shape.

In some embodiments, each of the magnetically permeable alloy layers may have an average thickness of between about 0.3 microns, or about 0.4 microns, or about 0.5 microns, or about 1 microns, or about micron, or about 1.5 microns, or about 2 microns, or about 2.5 microns, or about 3 microns and about 50 microns, or about 45 microns, or about 40 microns, or about 35 microns, or about 30 microns. In some embodiments, each of the adhesive layers may have an average thickness of between about 0.5 microns, or about 1 micron, or about 1.5 microns, or about 2 microns and about 20 microns, or about 15 microns, or about 10 microns. In some embodiments, H1 may be less than about 10 mm, or about 9 mm, or about 8 mm, or about 7 mm, or about 6 mm, or about 5 mm, or about 4 mm, or about 3 mm.

In some embodiments, at least one of opposing top and bottom major surfaces of the core may include a regular pattern comprising a plurality of substantially parallel features across the major surface. In some such embodiments, at least one of the features is a groove or similar linear artifact or structure. In some embodiments, the inclusion of grooves or similar features can provide an increase in surface area which can improve adhesion when the core is embedded in another material. These features may also be shown to improve issues with CTE (coefficient of thermal expansion) mismatch in parts assembled from multiple material types.

According to some aspects of the present description, a method of making a magnetically permeable core for use in a transformer includes the steps of providing a multilayer film having a plurality of alternating magnetically permeable alloy layers and adhesive layers, winding the multilayer film around a longitudinal axis to form a wound multilayer film with a plurality of substantially concentric turns of the multilayer film substantially centered on the longitudinal axis, and cutting the wound multilayer film into at least one slice along parallel radial planes to form the core. In some embodiments, the cutting includes one or more of saw cutting, laser cutting, water jet cutting, and die cutting. In some embodiments, the method further includes the step of intentionally cracking the magnetically permeable alloy layers across an entirety of the layers to form, in each of the layers, a plurality of interconnected cracks defining a plurality of magnetically permeable islands.

According to some aspects of the present description, a method of making a magnetically permeable core for use in a transformer includes the steps of providing a multilayer stack having a plurality of alternating magnetically permeable alloy layers and adhesive layers stacked along a first direction, and cutting the multilayer stack into at least one slice along parallel planes orthogonal to the first direction to form the core. In some embodiments, the cutting may include one or more of saw cutting, laser cutting, water jet cutting, and die cutting. In some embodiments, the method may further include the step of intentionally cracking the magnetically permeable alloy layers across an entirety of the layers to form before forming the multilayer stack, such that, in each of the layers, a plurality of interconnected cracks may define a plurality of magnetically permeable islands,

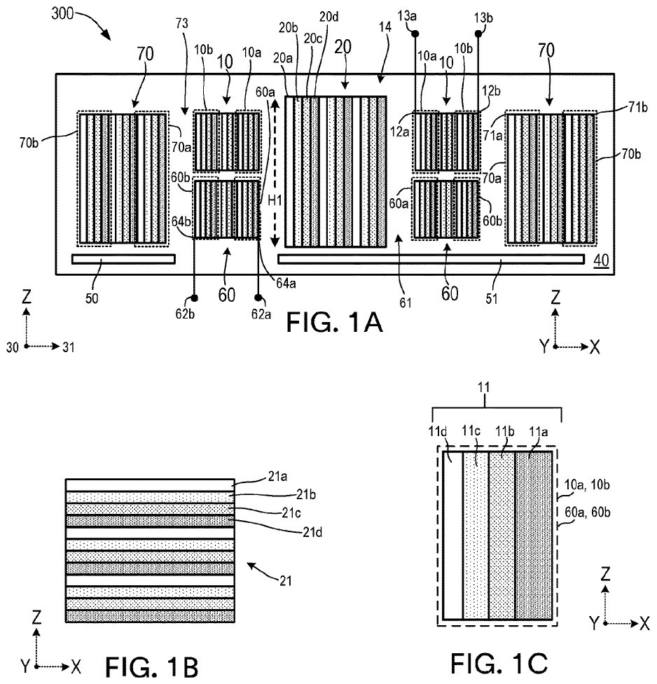

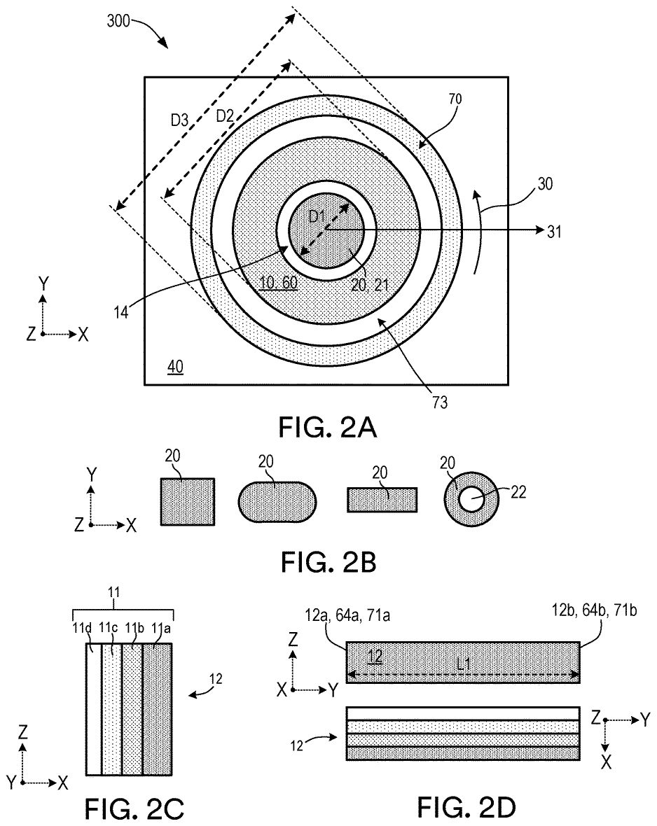

Turning now to the figures, FIGS. 1A-1C provide views of a generally planar transformer, according to the present description. FIGS. 2A-2D provide additional views of the same embodiment of a generally planar transformer. Each of these FIGS. (1A-1C, 2A-2D) may be referenced for the following discussion, and the figures should be examined together for the discussion.

In some embodiments, a generally planar transformer 300 lies in a base plane (e.g., the xy-plane defined by the Cartesian coordinate system shown in FIG. 1A) and defines an in-plane azimuth direction 30 and a radial direction 31, which are mutually orthogonal (e.g., see the coordinate system defining directions 30 and 31 in FIG. 1A, as well as directions 30 and 31 in FIG. 2A). In some embodiments, the generally planar transformer 300 includes a generally planar first coil portion 10 (e.g., a primary coil), and a generally planar core portion 20, 21.

Please note that FIG. 1A shows core portion 20 lying in one orientation and FIG. 1B shows core portion 21 in a different orientation. For most of the remaining discussion, the core portion will be referred to as core portion 20 for simplicity, unless the orientation shown for core portion 21 is specifically discussed. Other than orientation, the reference designators 20 and 21 may be used interchangeably when discussing the core portion.

It should also be noted that FIG. 1A is a cross-sectional view of one embodiment of a planar transformer 300, shown in contrast to FIG. 2A, which is a top, plan view of planar transformer 300. That is, FIG. 1A shows the planar transformer 300 of FIG. 2A as a cross-sectional view if one were to cut the planar transformer 300 of FIG. 2A in half (along a line parallel to the x-direction, or radial direction 31, shown in FIG. 2A). Therefore, the first coil portion 10 which appears as a ring in the top, plan view of FIG. 2A appears as two sections of first coil portion 10 when seen in the cross-sectional view of FIG. 1A, one section of first coil portion 10 appearing to the left of core portion 20 and another section of first coil portion 10 appearing on the right of core portion 20. This same note applies to generally planar second coil portion 60 and generally planar third coil portion 70, which are discussed elsewhere herein.

In some embodiments, core portion 20 may include a plurality of substantially planar (e.g., in the xy-plane, such as that shown in FIG. 1B) and co-extensive magnetically permeable layers 21b numbering at least 10, or at least 25, or at least 50, or at least 75, or at least 100, or at least 150, or at 200, or at least 250, or at least 300, or at least 350, or at least 400 in total, and bonded to each other and stacked along the height direction (e.g., the z-direction in FIG. 1B).

In some embodiments, generally planar first coil portion 10 is generally disposed in the base plane and includes a plurality of substantially concentric first coil loops 10a, 10b having an innermost first coil loop 10a and an outermost first coil loop 10b. In some embodiments, each of the first coil loops 10a, 10b may include a plurality of elongated first layers 11 (see FIG. 1C) elongated and extending along the azimuth direction 30 and stacked along the radial direction 31. In some embodiments, the plurality of elongated first layers 11 include at least one electrically conductive first layer 11a and at least one adhesive first layer 11d. In some embodiments, the plurality of elongated first layers 11 of each of the first coil loops 10a, 10b may further include at least one magnetically permeable first layer 11b. In some embodiments, the plurality of elongated first layers 11 of each of the first coil loops 10a, 10b may further include at least one non-adhesive electrically insulative first layer 11c.

In some embodiments, the generally planar first coil portion 10 includes a first multilayer film 12 (see FIG. 2D) extending between opposing first 12a and second 12b longitudinal ends of the first multilayer film 12 and wound to form the plurality of substantially concentric first coil loops 10a, 10b. In some embodiments, one of the innermost and outermost first coil loops (e.g., 10a) includes first longitudinal end 12a of the first multilayer film 12 and the other one of the innermost and outermost first coil loops (e.g., 10b) includes the second longitudinal end 12b of the first multilayer film 12. In some embodiments, the first 12a and second 12b longitudinal ends of the first multilayer film 12 may be electrically connected to respective first 13a and second 13b electrically conductive terminals.

In some embodiments, generally planar core portion 20 may be generally disposed in the base plane and, at least partially, in an opening 14 defined by the innermost first coil loop 10a of the first coil portion 10.

In some embodiments, planar core portion 20 may include a plurality of second layers 20a-20d stacked along radial direction 31 as shown in FIG. 1A, or planar core portion 21 (FIG. 1B) may include a plurality of second layers 21a-21d stacked along the height direction (e.g., along the z-direction of FIG. 1B). In some embodiments, the plurality of second layers 20a-20d, 21a-21d may include at least one magnetically permeable second layer 20b, 21b and at least one adhesive second layer 20d, 21d. In some embodiments, the plurality of second layers 20b, 21b may further include at least one electrically conductive second layer 20a, 21a. In some embodiments, the plurality of second layers 20b, 21b may further include at least one non-adhesive electrically insulative second layer 20c, 21c.

In some embodiments, the generally planar coil 10 portion and the generally planar core portion 20 may be at least partially embedded in an electrically insulative and magnetically non-permeable substrate 40. In some such embodiments, the substrate 40 may include a Flame Retardant 4 (FR4) substrate. In some embodiments, the generally planar transformer 300 may further include at least one ground layer 50, 51 embedded in substrate 40. In some embodiments, the term “non-permeable substrate” means a substrate with a permeability of 1.

In some embodiments, the generally planar transformer 300 may further include a generally planar second coil portion 60 (e.g., a secondary coil) generally disposed in the base plane and including a plurality of substantially concentric second coil loops 60a, 60b having an innermost second coil loop 60a and an outermost second coil loop 60b. In some embodiments, each of the second coil loops 60a, 60b may include a plurality of elongated third layers 11 (see FIGS. 1C and 2C) elongated and extending along the azimuth direction 30 and stacked along the radial direction 31. In some embodiments, the plurality of elongated third layers 11 may include at least one electrically conductive third layer 11a and at least one adhesive third layer 11d. In some embodiments, the plurality of elongated first layers 11 of each of the second coil loops 60a, 60b may further include at least one magnetically permeable first layer 11b. In some embodiments, the plurality of elongated first layers 11 of each of the second coil loops 60a, 60b may further include at least one non-adhesive electrically insulative first layer 11c. In some embodiments, generally planar core portion 20 may be at least partially disposed in an opening 61 defined by the innermost second coil loop 60a of second coil portion 60.

In some embodiments, the generally planar second coil portion 60 may include a second multilayer film 12 (see FIG. 2D) extending between opposing first 64a and second 64b longitudinal ends of the second multilayer film 12 and wound to form the plurality of substantially concentric second loops 60a, 60b, wherein one (e.g., 60a) of the innermost and outermost second coil loops 60a, 60b includes the first longitudinal end 64a of the second multilayer film 12 and the other one (e.g., 60b) of the innermost and outermost second coil loops 60a, 60b includes the second longitudinal end 64b of the second multilayer film 12. In some embodiments, the first 64a and second 64b longitudinal ends of the second multilayer film 12 may be electrically connected to respective third 62a and fourth 62b electrically conductive terminals.

In some embodiments, the generally planar transformer 300 may further include a generally planar third coil portion 70 including an elongated third multilayer film 12 elongated along a length L1 (see FIG. 2D) thereof between opposing first 71a and second 71b longitudinal ends of the elongated third multilayer film 12 and wound in the azimuth direction 30 to form a plurality of substantially concentric third coil loops 70a, 70b arranged along the radial direction 31 and having an innermost third coil loop 70a including the first longitudinal end 71a of the third multilayer film 12 and an outermost third coil loop 70b including the second longitudinal end 71b of third multilayer film 12. In some embodiments, the elongated third multilayer film 12c may include a plurality of elongated third layers 11 (see FIG. 2C) having at least one magnetically permeable third layer 11a and at least one adhesive third layer 11d. In some embodiments, the generally planar first coil portion 10 and the generally planar core portion 20 are disposed, at least partially, in an opening 73 defined by the innermost third coil loop 70a of the generally planar third coil portion 70.

In some embodiments, an average height H1 (see FIG. 1A) of the generally planar core portion 20 along the height direction (e.g., the z-axis) may be less than about 10 mm, or less than about 9 mm, or less than about 8 mm, or less than about 7 mm, or less than about 6 mm, or less than about 5 mm, or less than about 4 mm, or less than about 3 mm, or less than about 2 mm, or less than about 1 mm. In some embodiments, the core may have an average height H1 in the height direction and a largest lateral dimension D1 (see FIG. 2A), such that the ratio of D1/H1 is greater than or equal to about 2, or about 3, or about 4, or about 5, or about 10, or about 15, or about 20.

Continuing to look at FIG. 2A, the largest lateral dimension D1 of the generally planar core portion 20 may be less than about 50 mm, or less than about 45 mm, or less than about 40 mm, or less than about 35 mm, or less than about 30 mm, or less than about 25 mm, or less than about 20 mm, or less than about 15 mm, or less than about 10 mm.

In some embodiments, a largest lateral dimension D2 of the generally planar first coil portion 10 (or generally planar second coil portion 60, if appropriate) may be less than about 50 mm, or less than about 45 mm, or less than about 40 mm, or less than about 35 mm, or less than about 30 mm, or less than about 25 mm, or less than about 20 mm, or less than about 15 mm, or less than about 10 mm.

In some embodiments, a largest lateral dimension D3 of the generally planar third coil portion 70 may be less than about 200 mm, or less than about 175 mm, or less than about 150 mm, or less than about 125 mm, or less than about 100 mm, or less than about 75 mm, or less than about 50 mm, or less than about 45 mm, or less than about 40 mm, or less than about 35 mm, or less than about 30 mm.

Looking at FIG. 2B, as seen from a top planar view, the generally planar core portion 20 may have any appropriate shape, including but not limited to a square, an oval, a rectangle, a circle (including a disc, toroid, doughnut, ellipsoid, coil, or other appropriate shape). In some embodiments, the generally planar core portion 20 may define a central opening (e.g., a through-opening) 22 extending across an entire thickness of the core portion 20.

FIGS. 2C and 2D illustrate an elongated third multilayer film 12 and is discussed in additional detail elsewhere herein.

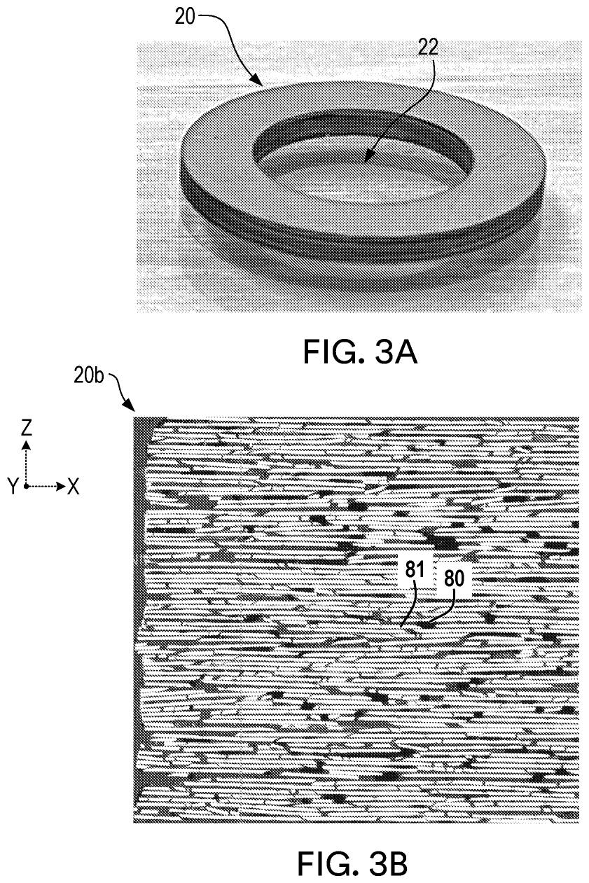

FIGS. 3A-3B are images of a magnetically permeable second layer (such as magnetically permeable second layer 20b) of a generally planar core portion 20 which has been intentionally cracked to form cracks defining magnetically permeable islands. FIG. 3A shows a perspective image of a generally planar core (or core portion) 20 with central through-opening 22. FIG. 3B is a close-up image of a magnetically permeable second layer 20b (of generally planar core portion 20) which has been intentionally cracked across substantially an entirety of second layer 20b to form a plurality of interconnected cracks 80 defining a plurality of magnetically permeable islands 81.

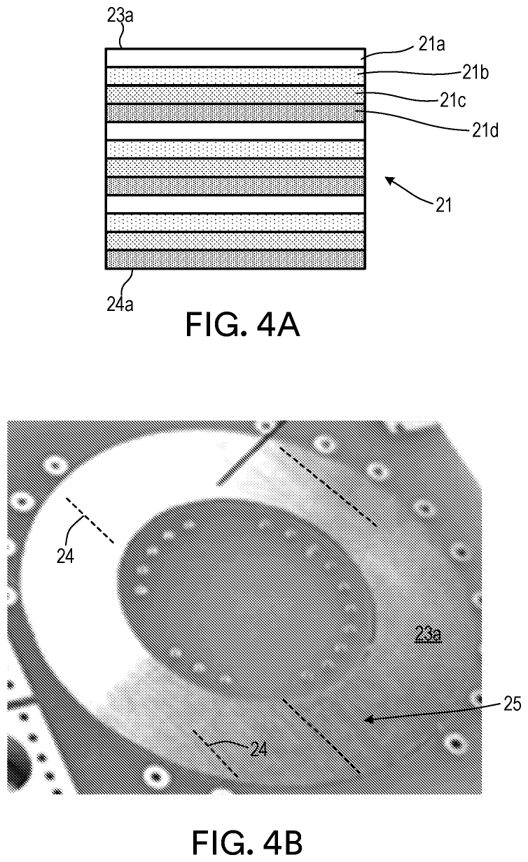

FIGS. 4A-4B illustrate how the surfaces of a magnetically permeable core may include a regular pattern of parallel features, according to the present description. FIG. 4A is an illustration of a magnetically permeable core 21 including a plurality of second layers 21a through 21d and having an opposing top 23a and bottom 23b major surfaces of the core 21. In some embodiments, at least one of the opposing top major surface 23a and the bottom major surface 23b may include a regular pattern 25 including a plurality of substantially parallel features 24 across the major surface (see, for example, the image of top major surface 23a of FIG. 4B). In some embodiments, at least one of the features 24 is a groove. For clarity, dashed lines are shown in FIG. 4B to highlight some of the parallel features 24.

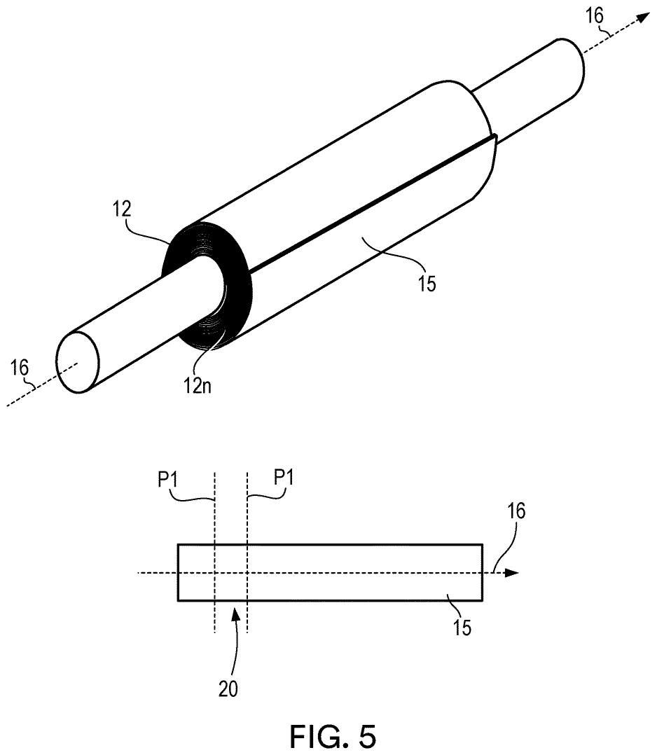

FIG. 5 illustrates one method of making a magnetically permeable core for use in a transformer, such as the embodiment of magnetically permeable core 20 discussed elsewhere herein. In some embodiments, the method may include providing a multilayer film 12 (see also multilayer film of FIGS. 2C and 2D), the multilayer film 12 including at least a plurality of alternating magnetically permeable alloy layers 21b and adhesive layers 21d; winding the multilayer film 12 around a longitudinal axis 16 to form a wound multilayer film 15. In some embodiments, the wound multilayer film may include a plurality of substantially concentric turns 12n of the multilayer film 12 substantially centered on the longitudinal axis 16; and cutting the wound multilayer film 15 into at least one slice along parallel radial planes P1, P2 to form the core 20. In some embodiments, the cutting step may include one or more of saw cutting, laser cutting, water jet cutting, and die cutting.

In some embodiments, the method of making a magnetically permeable core may further include intentionally cracking the magnetically permeable alloy layers 21b across an entirety of the layers to form, in each of the layers, a plurality of interconnected cracks 80 defining a plurality of magnetically permeable islands 81 (see, e.g., FIG. 3B).

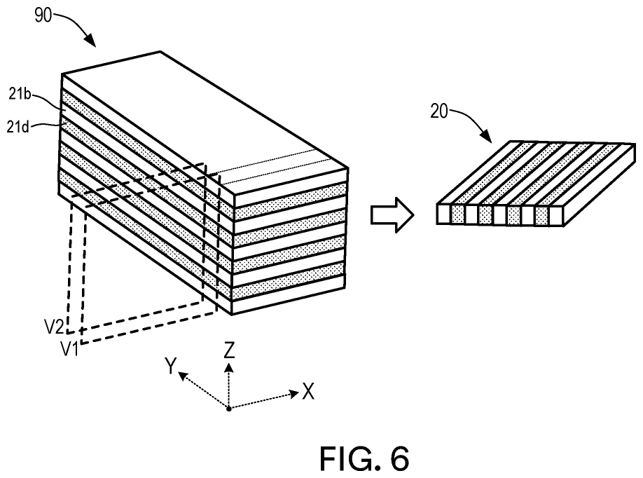

Finally, FIG. 6 illustrates another method of making a magnetically permeable core for use in a transformer, such as the embodiment of magnetically permeable core 20 discussed elsewhere herein. In some embodiments, the method may include the steps of providing a multilayer stack 90 including at least a plurality of alternating magnetically permeable alloy layers 21b and adhesive layers 21d stacked along a first direction (e.g., the z-axis shown in FIG. 6), and cutting the multilayer stack into at least one slice along parallel planes V1, V2 orthogonal to the first direction (e.g., along the x-direction of FIG. 6) to form the core 20. In some embodiments, the cutting step may include one or more of saw cutting, laser cutting, water jet cutting, and die cutting. In some embodiments, the method may further include intentionally cracking, before forming the multilayer stack 90, the magnetically permeable alloy layers 21b across an entirety of the layers to form, in each of the layers, a plurality of interconnected cracks 80 defining a plurality of magnetically permeable islands 81 (see, e.g., FIG. 3B).

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A generally planar transformer generally lying in a base plane defining mutually orthogonal in-plane azimuth and radial directions, the generally planar transformer comprising:
a generally planar first coil portion generally disposed in the base plane and comprising a plurality of substantially concentric first coil loops comprising an innermost first coil loop and an outermost first coil loop, each of the first coil loops comprising a plurality of elongated first layers elongated and extending along the azimuth direction and stacked along the radial direction, the plurality of elongated first layers comprising at least one electrically conductive first layer and at least one adhesive first layer; and
a generally planar core portion generally disposed in the base plane and, at least partially, in an opening defined by the innermost first coil loop of the first coil portion and comprising a plurality of second layers stacked along one of the radial direction and a height direction orthogonal to the base plane, the plurality of second layers comprising at least one magnetically permeable second layer and at least one adhesive second layer.

2. The generally planar transformer of claim 1, wherein the generally planar first coil portion comprises a first multilayer film extending between opposing first and second longitudinal ends of the first multilayer film and wound to form the plurality of substantially concentric first coil loops, wherein one of the innermost and outermost first coil loops comprises the first longitudinal end of the first multilayer film and the other one of the innermost and outermost first coil loops comprises the second longitudinal end of the first multilayer film.

3. The generally planar transformer of claim 2, wherein the first and second longitudinal ends of the first multilayer film are electrically connected to respective first and second electrically conductive terminals.

4. The generally planar transformer of claim 1, wherein any magnetic permeability of any first layer in the plurality of elongated first layers of each of the first coil loops is substantially smaller than a magnetic permeability of the at least one magnetically conductive second layer in the plurality of second layers.

5. The generally planar transformer of claim 1, wherein any electrical conductivity of any second layer in the plurality of second layers is substantially smaller than an electrical conductivity of the at least one electrically conductive first layer in the plurality of elongated first layers of each of the first coil loop.

6. The generally planar transformer of claim 1, wherein the plurality of elongated first layers of each of the first coil loops further comprises at least one magnetically permeable first layer.

7. The generally planar transformer of claim 1, wherein the plurality of elongated first layers of each of the first coil loops further comprises at least one non-adhesive electrically insulative first layer.

8. The generally planar transformer of claim 1, wherein the plurality of second layers further comprises at least one electrically conductive second layer.

9. The generally planar transformer of claim 1, wherein the plurality of second layers further comprises at least one non-adhesive electrically insulative second layer.

10. The generally planar transformer of claim 1, wherein the generally planar coil and core portions are at least partially embedded in an electrically insulative and magnetically non-permeable substrate.

11. The generally planar transformer of claim 1, wherein the second layers in the generally planar core portion are stacked along the height direction.

12. The generally planar transformer of claim 1, wherein the second layers in the generally planar core portion are stacked along the radial direction.

13. The generally planar transformer of claim 1 further comprising a generally planar second coil portion generally disposed in the base plane and comprising a plurality of substantially concentric second coil loops comprising an innermost second coil loop and an outermost second coil loop, each of the second coil loops comprising a plurality of elongated third layers elongated and extending along the azimuth direction and stacked along the radial direction, the plurality of elongated third layers comprising at least one electrically conductive third layer and at least one adhesive third layer.

14. The generally planar transformer of claim 13, wherein the generally planar core portion is at least partially disposed in an opening defined by the innermost second coil loop of the second coil portion.

15. The generally planar transformer of claim 13, wherein the generally planar second coil portion comprises a second multilayer film extending between opposing first and second longitudinal ends of the second multilayer film and wound to form the plurality of substantially concentric second loops, wherein one of the innermost and outermost second coil loops comprises the first longitudinal end of the second multilayer film and the other one of the innermost and outermost second coil loops comprises the second longitudinal end of the second multilayer film.

16. The generally planar transformer of claim 1, wherein the at least one magnetically permeable second layer comprises one or more of magnetically conductive ferrite, soft magnet, metal, crystalline alloy, nanocrystalline alloy, amorphous alloy, and composite.

17. The generally planar transformer of claim 1 further comprising a generally planar third coil portion comprising an elongated third multilayer film elongated along a length thereof between opposing first and second longitudinal ends of the elongated third multilayer film and wound in the azimuth direction to form a plurality of substantially concentric third coil loops arranged along the radial direction and comprising an innermost third coil loop comprising the first longitudinal end of the third multilayer film and an outermost third coil loop comprising the second longitudinal end of the third multilayer film, the elongated third multilayer film comprising a plurality of elongated third layers comprising at least one magnetically permeable third layer and at least one adhesive third layer, wherein the generally planar first coil portion and the a generally planar core portion are disposed, at least partially, in an opening defined by the innermost third coil loop of the generally planar third coil portion.

18. A magnetically permeable core for use in a transformer and having an average height H1 in a height direction and a largest lateral dimension D1, D1/H1≥2, the magnetically permeable core comprising a plurality of substantially planar and co-extensive magnetically permeable alloy layers numbering at least 50 in total stacked along the lateral direction and bonded to each other via a plurality of adhesive layers, wherein the magnetically permeable alloy layers are intentionally cracked across substantially an entirety of the layers to form a plurality of magnetically permeable alloy islands isolated from each other by a plurality of interconnected cracks.

19. The magnetically permeable core of claim 18 having a shape of a disc, a toroid, a doughnut, an ellipsoid, or a coil.

20. The magnetically permeable core of claim 19, wherein the disc-shaped core has at least one central through-opening.
